(19) United States
(12) Patent Application Publication
(10) Pub. No.: US 2008/0118410 A1
(43) Pub. Date: May 22, 2008

(54) Exhaust Gas Cleaner

(76) Inventors: Takatoshi Furukawa, Tokyo (JP); Koichi Machida, Tokyo (JP); Ichiro Tsumagari, Tokyo (JP); Yoshihide Takenaka, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/718,307

(22) PCT Filed: Oct. 27, 2005
(86) PCT No.: PCT/JP05/19756

§ 371 Date: Apr. 30, 2007

(30) Foreign Application Priority Data
Oct. 28, 2004 (JP) 2004-313743
Nov. 18, 2004 (JP) 2004-334579

(51) Int. Cl. F01N 3/38; B01J 19/08; B01J 19/12

(52) U.S. Cl. 422/186.03; 422/174; 422/186.04

(57) ABSTRACT

An exhaust emission control device with a plasma generator received in a filter casing incorporated in an exhaust pipe for capturing particulates and capable of conducting electric discharge so as to generate plasma in the exhaust gas at a capturing place and with a power supply for impressing voltage on the plasma generator. The plasma generator is unitized and arranged in plurality. A control switch is provided for sequential changeover of the connection of the power supply to the plural units of the plasma generator. A processing capability comparable to a single, large-sized plasma generator is obtained while increase in size of the power supply is prevented.

### TECHNICAL FIELD

The present invention relates to an exhaust emission control device for removing particulates from exhaust gas of an internal combustion engine such as diesel engine.

### BACKGROUND ART

Particulates or particulate matter from a diesel engine is mainly constituted by carbonic soot and a soluble organic fraction (SOF) of high-boiling hydrocarbon and contains a trace of sulfate (misty sulfuric acid fraction). In order to suppress such kind of particulates from being discharged into atmosphere, it has been conventionally carried out that a particulate filter is incorporated in an exhaust pipe through which exhaust gas flows.

This kind of particulate filter is a porous honeycomb structure made of ceramics such as cordierite and having lattice-like compartmentalized passages. Alternate ones of the passages have plugged inlets and the remaining passages with unplugged open inlets are plugged at their outlets. Thus, only the exhaust gas passing through the thin porous compartment walls is discharged downstream.

The particulates in the exhaust gas are captured by and accumulated on inner surfaces of the thin porous walls and spontaneously ignite to be burned off upon shifting to a region of operation with increased exhaust temperature. However, when an operation or driving with temperature at or above a predetermined temperature requisite tends not to continue for a long time in a vehicle such as a shuttle-bus running mainly on congested city roads, there may be a fear that an accumulated particle amount exceeds a treated amount, disadvantageously resulting in clogging of the particulate filter.

Thus, development of an exhaust emission control device has been promoted so as to satisfactorily burn off the particulates even in a region of operation with lower exhaust temperature. In this kind of exhaust emission control device, generation of plasma in the exhaust gas by plasma generating means excites the exhaust gas to generate active radicals such as O and OH radicals, which makes it possible to satisfactorily burn off the particles even in a region of operation with lower exhaust temperature.

As disclosed in References 1 and 2 mentioned below, the plasma generating means may comprise perforated cylindrical outer and inner electrodes made of stainless steel ceramic pellets being charged between the electrodes to provide dielectrics; exhaust gas is passed through the pellet-charged layer so as to capture particles in the exhaust gas while plasma is generated between the outer and inner electrodes.

[Reference 1] JP 2002-501813A

[Reference 2] JP 2002-511332A

### SUMMARY OF THE INVENTION

### Problems to be Solved by the Invention

However, when such plasma generating means in an exhaust emission control device is increased in size into a large-sized one, electrostatic capacity of the plasma generating means accordingly increases to increase reactive power, resulting in necessity of high-capacity transformer. As a result, cost of production is disadvantageously increased due to the large-sized power supply means.

Moreover, almost all of the conventionally proposed, plasma-assisted exhaust emission control devices are based on a design concept that cylindrical outer and inner electrodes are concentrically arranged, so that when filter means (the pellet-charged layer or the like in References 1 and 2) between the outer and inner electrodes is to have a larger capturing area, diameters of the outer and inner electrodes must be increased while a distance between the electrodes is kept short, which disadvantageously results in formation of large central dead space. This lowers spatial efficiency and deteriorates mountability to a vehicle.

The invention was made in view of the above and has its object to provide an exhaust emission control device which prevents large-sized power supply means in association with large-sized plasma generating means, and to provide a plasma-assisted exhaust emission control device with good spatial efficiency for improved mountability of the exhaust emission control device to a vehicle.

### Means or Measures for Solving the Problems

According to a first aspect of the invention, the invention is directed to an exhaust emission control device with plasma generating means received in a filter casing incorporated in an exhaust pipe for capturing particulates and capable of conducting electric discharge so as to generate plasma in the exhaust gas at a capturing place and with power supply means for impressing voltage on the plasma generating means, said device comprising a plurality of unitized or units of plasma generating means and a control switch for sequential changeover of connection of said power supply means to said plurality of units of plasma generating means.

In the invention, one or more of power supply means may be connected to the plural units of plasma generating means.

In the invention, one power supply means may be connected to two of the units of plasma generating means.

Thus, according to the invention, the plasma generating means are unitized and arranged in plurality so that they can have processing capacity comparable to that of a single, large-sized plasma generating means. By changing over the connection to the plural units of plasma generating means through the control switch, increase in size of the power supply means can be prevented to reduce the cost of production.

By connecting one or more power supply means to the plural plasma generating means, degree of freedom in connection between the units of plasma generating means and the power supply means so that particulates can be flexibly and readily dealt with, and increase in size of the power supply means can be prevented to reduce the cost of production.

By connecting one power supply means to two of the units of plasma generating means, the number of the power supply means can be reduced to prevent increase in size of the power supply means and to substantially reduce the cost of production.

According to a second aspect of the invention, the invention is directed to an exhaust emission control device comprising a pair of flat-plate electrodes arranged opposite to each other with a gap to provide a vent structure, a plurality of electrode rods arranged between the electrodes and in parallel with each other and each facing via plasma generating space to the corresponding electrode, the electrode rods being insulation-coated by dielectrics and filter means constituted by at least either of the electrodes or the plasma generating spaces the exhaust gas being introduced from upstream into introduction space defined by two arrays of electrode rods and being passed through gaps between the respective electrode rods, the plasma generating spaces and the electrodes into downstream voltage necessary for electric discharge being impressible between the electrodes and electrode rods to thereby provide the plasma assisted type plasma generating means (exhaust purification unit), the plasma generating means (exhaust purification unit) being arranged in parallel with each with directions of introducing the exhaust gas being the same, exhaust space being assured between the adjacent plasma generating means (exhaust purification units) so as to guide the exhaust gas having passed through the electrodes into downstream.

Upon carrying out the invention more concretely, the flat-plate electrodes themselves may be provided as filter means; alternatively or in addition filter means may be provided in the plasma generating spaces. From the viewpoint of preventing attachment and accumulation of the particulates on the electric supply systems the electric supply system is preferably arranged downstream with respect to the direction of flow of exhaust gas.

In the exhaust emission control device thus constructed, the exhaust gas from upstream is introduced into introduction spaces of the respective exhaust purification units and is passed through gaps between the electrode rods via the plasma generating spaces and flat-plate electrodes into downstream. As this exhaust gas is passed through the filter means constituted by at least either of the flat-plate electrodes and plasma generating spaces, the particulates are captured so that, as needed, impression of required voltage between the electrodes and the corresponding electrode rods brings about barrier discharge between the electrodes and the electrode rods insulation-coated, whereby low-temperature plasma (nonthermal equilibrium plasma) is generated in the plasma generating spaces. As a result, exhaust gas is excited to generate active radicals such as O and OH radicals. BY the help of these exhaust gas excite components, the particulates are effectively burned off (oxidized).

In this connection, each plasma generating means (exhaust purification unit) employs a spatially non-wasteful structure with the flat-plate electrodes and the arrays of electrode rods being oppositely arranged, so that the capturing area may be increased with no substantial increase in wasteful space by planar increase of the flat-plate electrodes and the arrays of electrode rods while the distance between the electrodes is kept short. Moreover, increase in number of the arranged plasma generating means (the exhaust purification units) may also effectively increase the capturing area. Thus, a plasma-assisted exhaust emission control device may be realized which has better spatial efficiency than the conventional devices.

### EFFECTS OF THE INVENTION

According to the above-mentioned exhaust emission control device of the invention, excellent features and advantages as mentioned below can be obtained.

### (I) According to the first aspect of the invention, processing ability comparable to that of a single, large-sized plasma generating means can be obtained and power supply means can be prevented from being increased in size.

(II) According to the second aspect of the invention, a plasma-assisted exhaust emission control device may be realized which has better spatial efficiency than the conventional devices. As a result, mountability of an exhaust emission control device to a vehicle can be substantially improved and, by merely increasing or decreasing in number of the arranged plasma generating means (exhaust purification units), a proper capacity control can be made depending upon engine exhaust amount and particulate discharge amount.
(III) By arranging the electric supply system at downstream side in the direction of flow of the exhaust gas, the electric supply system can be protected so as not to be exposed to the exhaust gas with particulates entrained. As a result, preliminarily preventable are attachment and accumulation of the particulates on exposed portions of the electric supply system into short circulation.

### BRIEF DESCRIPTION OF THE DRAWINGS

FIG. 1 A schematic view showing a first embodiment of the invention.

FIG. 2 A plan view showing a schematic structure of a unit of plasma generating means and a unit of power supply means.

FIG. 3 A perspective view showing a unit of plasma generating means from front side.

FIG. 4 A perspective view showing the unit of FIG. 3 with a front insulating structure being removed.

FIG. 5 A perspective view showing a unit of plasma generating means from rear side.

FIG. 6 A perspective view showing the unit of FIG. 5 with a rear insulating structure being removed.

FIG. 7 A perspective view from rear side showing a plurality of units of plasma generating means arranged in parallel with each other.

FIG. 8 A conceptual diagram showing connections of a plurality of units of plasma generating means with a unit of power supply means.

FIG. 9 A conceptual diagram showing connections of a plurality of units of plasma generating means with units of power supply means according to a second embodiment of the invention.

FIG. 10 A conceptual diagram showing connections of a plurality of units of plasma generating means with a unit of power supply means according to a third embodiment of the invention.

### EXPLANATION OF THE REFERENCE NUMERALS

8 exhaust gas
9 exhaust pipe
10 exhaust emission control device
12 plasma generating means (exhaust purification unit)
13 insulating structure
14 insulating structure
15 flat-plate electrode (filter means)
16 plasma generating space
17 dielectric
18 electrode rod
19 introduction space
22 power feeder
23 power supply means
24 exhaust space
26 control switch

### BEST MODE FOR CARRYING OUT THE INVENTION

A first embodiment of the invention will be described in conjunction with the drawings.

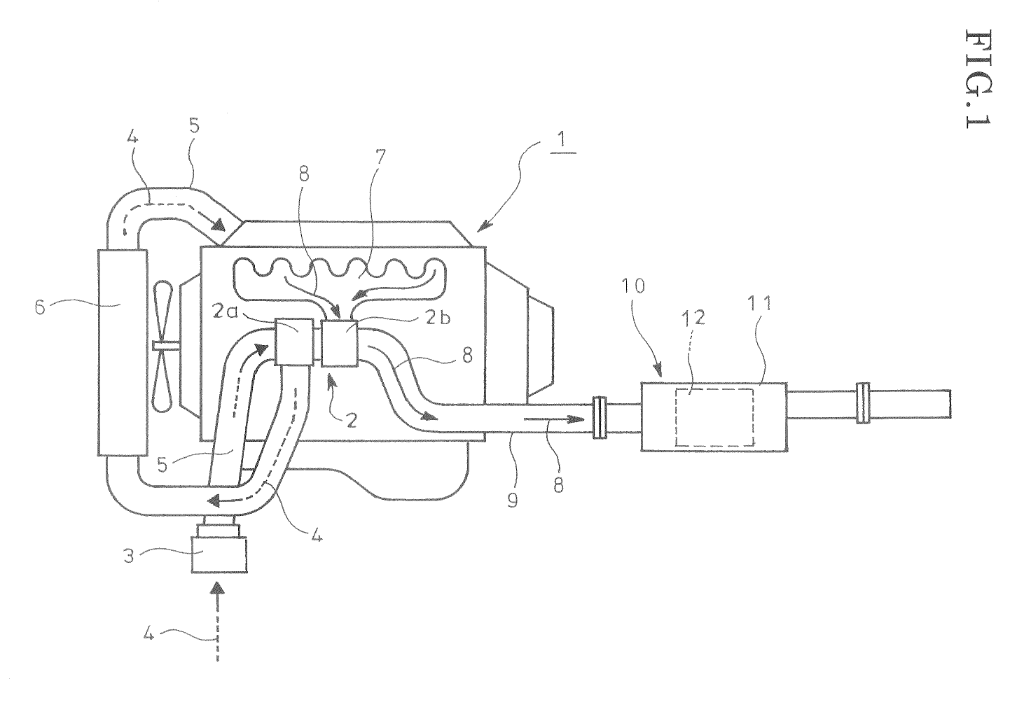

FIGS. 1-8 show the first embodiment of the invention. In FIG. 1, reference numeral 1 denotes a diesel engine (internal combustion engine) with a turbocharger 2 having a compressor 2a to which intake air 4 is introduced for pressurization via an air cleaner 3 and an intake pipe 5, the pressurized intake air 4 being distributed via an intercooler 6 to each cylinder of the diesel engine 1.

Exhaust gas 8 discharged from the cylinders of the diesel engine 1 via an exhaust manifold 7 is fed to a turbine 2b of the turbocharger 2. The exhaust gas 8 having driven the turbine 2b is passed through a plasma assisted exhaust emission control device 10 incorporated in an exhaust pipe 9 for capture of particulates and then is discharged.

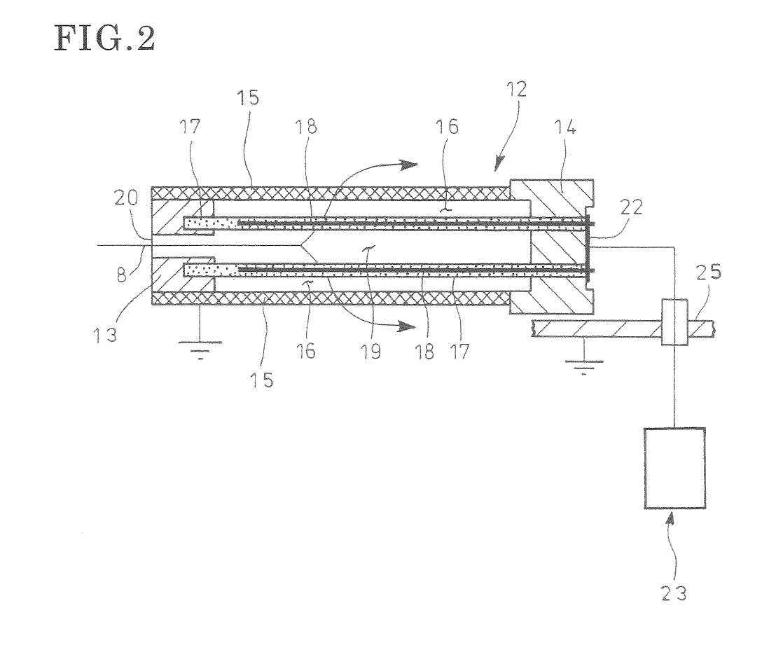

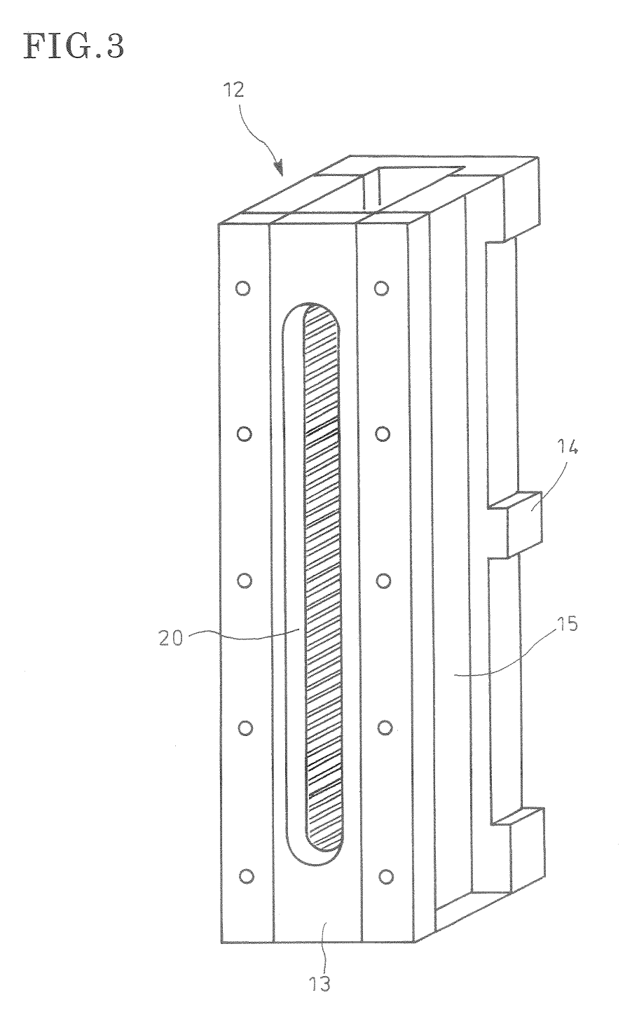

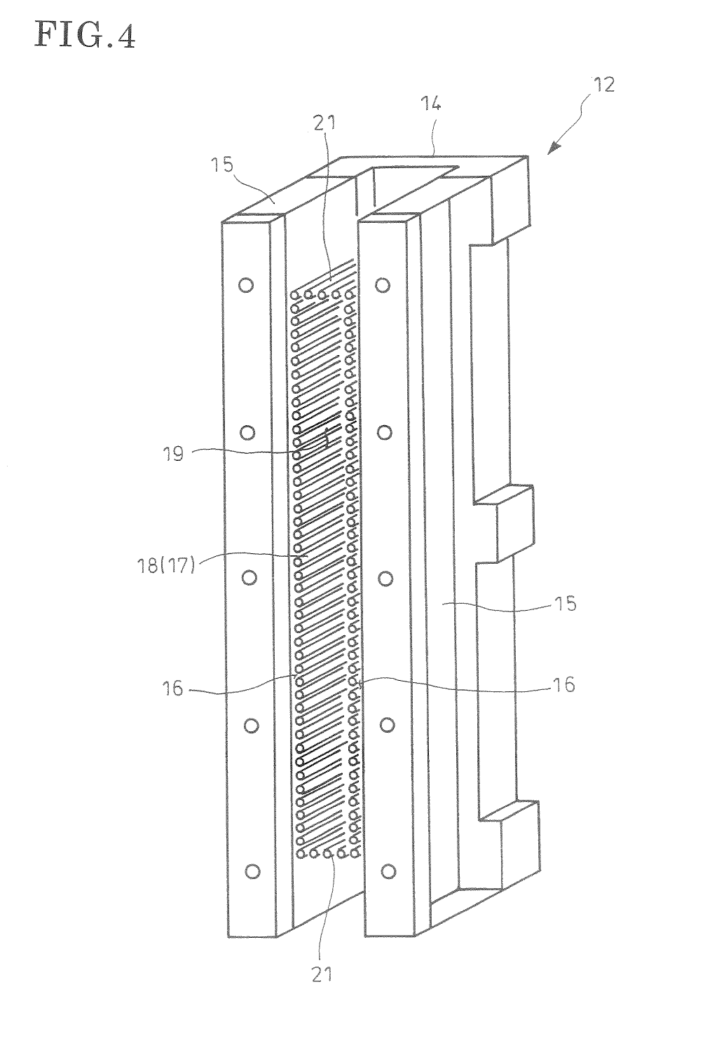

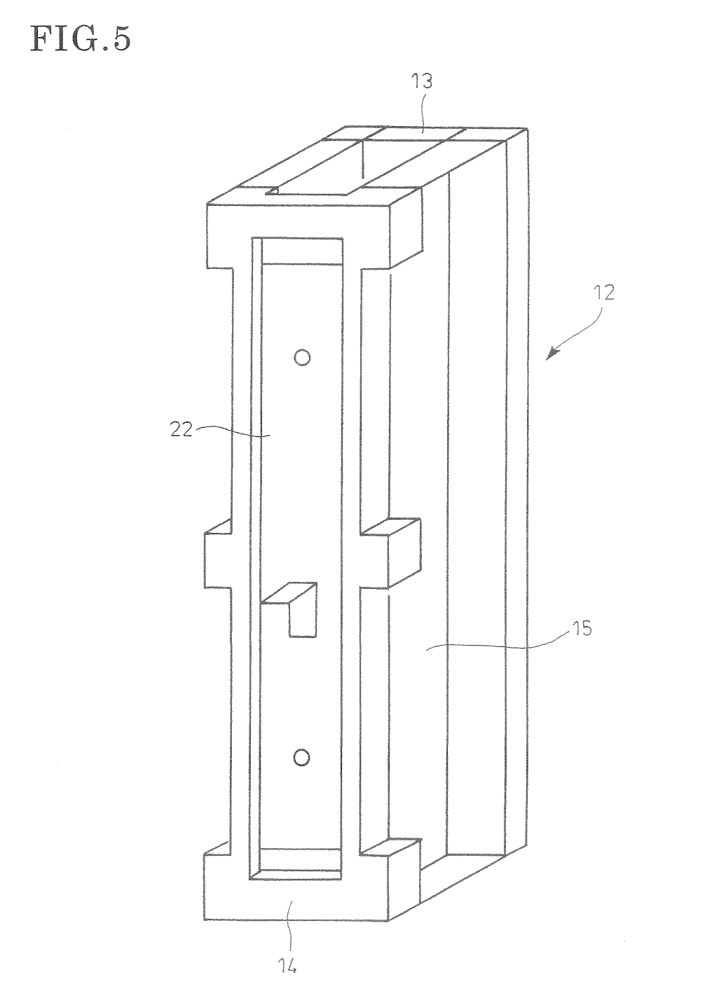

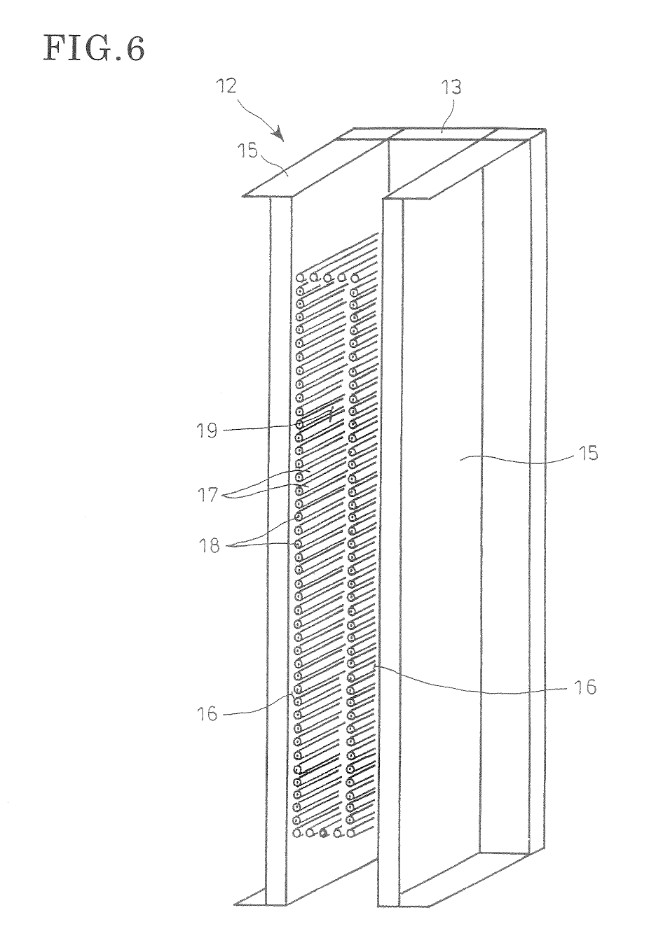

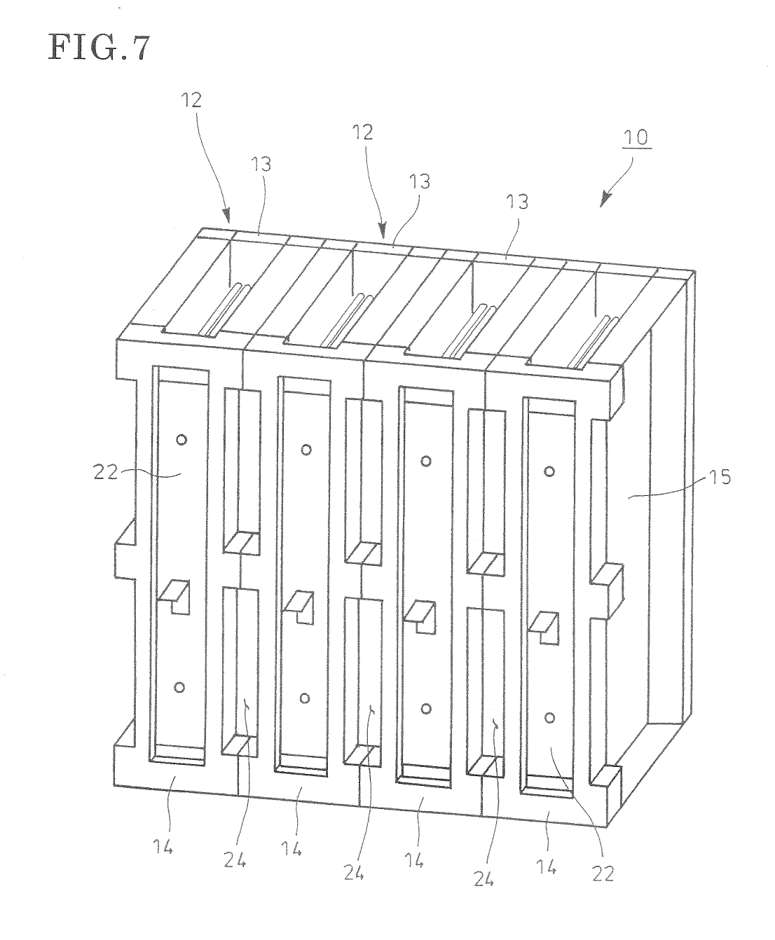

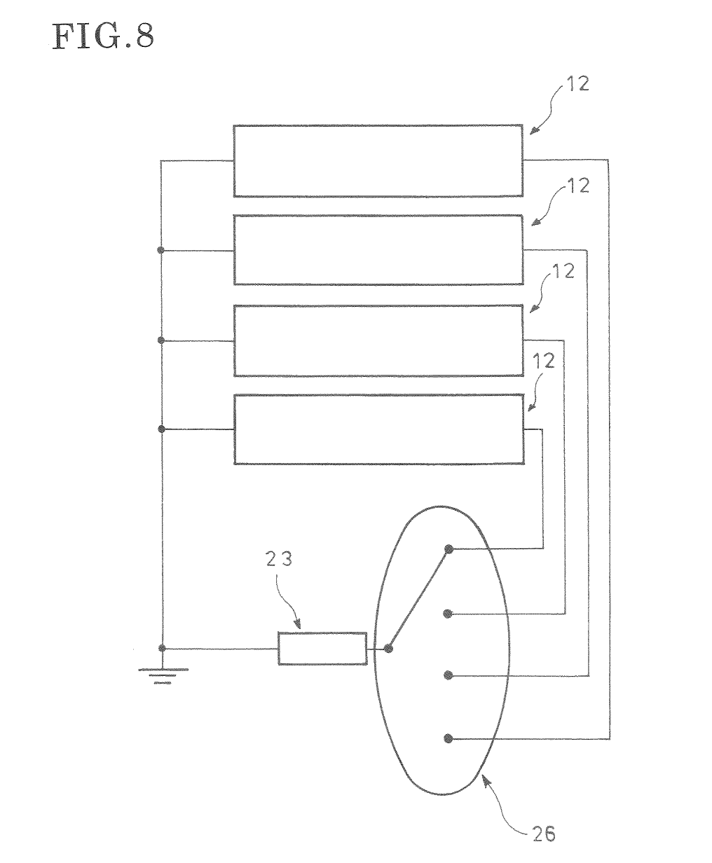

The exhaust emission control device 10 comprises unitized plasma generating means 12 as mentioned hereinafter in details with reference to FIGS. 1-8 which are arranged in parallel with each other and carried by a filter casing 11, and a unitized power supply means 23. FIG. 2 is a plan view showing a schematic structure of a unit of plasma generating means 12; FIG. 3 is a perspective view showing a unit of plasma generating means 12 from front side; FIG. 4 is a perspective view showing the unit of FIG. 3 with a front insulating structure 14 being removed; FIG. 5 is a perspective view showing a unit of plasma generating means 12 from rear side: FIG. 6 is a perspective view showing the unit of FIG. 5 with a rear insulating structure 14 being removed; FIG. 7 is a perspective view from rear side showing a plurality of units of plasma generating means 12 arranged in parallel with each other; and FIG. 8 is a conceptual diagram showing connections of a plurality of units of plasma generating means 12 with a unit of power supply means 23.

The plasma generating means (exhaust purification unit) 12 comprises a pair of flat-plate electrodes 15 arranged opposite to each other to provide a vent structure, and a plurality of electrode rods 18 arrayed between the electrodes 15 and in parallel with each other with a spacing on the order of several mm and each facing via plasma generating space 16 to the corresponding electrode 15, the electrode rods 18 being insulation-coated by dielectrics 17 the electrodes 15 and the electrode rods 18 being supported at their opposite ends by insulating structures 13 and 14.

In this embodiment, the flat-plate electrodes 15 are exemplified to constitute themselves filter means. More specifically the electrodes 15 are made up by metal filters capable of capturing the particulates to provide the vent structure.

Adaptable as this kind of metal filter is, for example, a sintered layer of micronized metal fiber, a sintered body of metal powder, a sintered layer of metal mesh or metal mesh with metal powder sintered.

The plasma generating space 16 may be alternatively charged with honeycomb filter of cordierite, fibrous filter of ceramics ceramic foam or alumina pellets as filter means. In such a case, the flat-plate electrodes 15 may not always be made up by filter means, but by metal mesh or punching metal so as to provide a simple vent structure. Alternatively, of course, the flat-plate electrodes 15 constituting themselves as filter means may be combined with the filter means in the plasma generating spaces 16 for the purpose of attaining higher capturing rate.

To charge the dielectric particles such as ceramic pellets into the plasma generating spaces 16 to provide the filter means will contribute to easiness in generation of low-temperature plasma since electric charge is gathered on respective contacts of the pellets or particles to form high local electric field (the same effect can be also obtained when ceramic fiber or foam is charged). Moreover, the interposition of the filter means in the plasma generating spaces 16 to provide a great number of planes extending perpendicularly between the opposing flat-plate electrode 15 and electrode rods 18, creepage surface electric discharge along the planes are facilitated, leading to easiness in generation of low-temperature plasma.

The front insulating structure 13 is formed with a gas inlet 20 for introduction of the exhaust gas 8 into the introduction space 19 defined by the two arrays of electrode rods 18 whereas the rear insulating structure 14 is a closed structure for blockage of the flow of the exhaust gas 8 in such a manner that the exhaust gas 8 introduced from upstream side via the gas inlet 20 into the space 19 is made to flow through gaps in the arrays of the electrode rods 18 into downstream via the plasma generating spaces 16 and flat-plate electrodes 15.

At a top and a bottom of the two arrays of the electrode rods 18, dummy pipes 21 of dielectrics are laterally arrayed to suppress the exhaust gas 8 from vertically bypassing the respective arrays of the electrode rods 18. Opened upper and lower portions of the introduction space 19 is adapted to be closed by an enclosure 25 only a portion of which is shown in FIG. 2.

Rear ends of the respective electrode rods 18 extend through the rear insulating structure 14 to protrude from the insulating structure 14 to provide a power feeder 22 comprising a conductor plate. The power feeder 22 is connected through the enclosure 25 to the power supply means 23 outside the filter casing 11, the respective flat-plate electrodes 15 being earthed, whereby AC high voltage (or DC pulse high voltage) necessary for electric discharge may be impressed between the respective flat-plate electrodes 15 and the respective electrode rods 18.

A plurality of units each comprising the plasma generating means 12 are arranged in parallel with each other as shown in FIG. 7 into an assembly of units (four units in FIG. 7). The unit assembly is such that the directions of introducing the exhaust gas 8 are the same and exhaust space 24 is assured between the adjacent units so as to guide downstream the exhaust gas 8 having passed through the electrodes 15, thereby providing the plasma assisted exhaust emission control device 10.

In order to assure the exhaust space 24 between the respective plasma generating means (the respective exhaust purification units) 12, each of three edges except a rear edge of a the flat-plate electrodes 15 may have laterally outward extensions, and the rear insulating structure 14 may be formed with laterally outward partial projections (upper and middle and lower projections in the figures) (see FIGS. 3-7).

As shown in FIG. 8, the single power supply means 23 constitutes a unit, the unit of power supply means 23 being switchably connected to the units of plasma generating means 12 via a control switch 26. The unit of power supply means 23 is provided with a transformer with a predetermined capacity corresponding to the electrostatic capacity of the single unit of plasma generating means 12.

The control switch 26 is controlled such that the connection of the single unit of power supply means 23 is sequentially changed over to all units of plasma generating means 12. The changeover sequence of the control switch 26 may be, for example, such that accumulation of the particles in one of the units of plasma generating means over a predetermined amount is detected to trigger the changeover; alternatively, the changeover may be conducted in a constant sequence and at a constant time interval. There is no specific limitation on the changeover.

When the exhaust gas 8 is caused to flow through such exhaust emission control device 10, the exhaust gas 8 from upstream is guided to the introduction spaces 19 of the respective plasma generating means 12 and is passed through the gaps of the arrays of electrode rods 18, the plasma generating spaces 16 and the electrodes 15 into downstream. As the exhaust gas 8 is passed through the electrodes 15 providing the metal filters, the particulates are captured so that, as needed, impression of DC pulse high voltage between the electrodes 15 and electrode rods 18 by the unit of power supply means 23 brings about barrier discharge between the electrodes 15 and the elect rode rods 18 insulation coated by the dielectrics 17, whereby low-temperature plasma (nonthermal equilibrium plasma) is generated in the plasma generating spaces 16. As a result, the exhaust gas 8 is excited to generate active radicals such as O and OH radicals. By the help of these exhaust gas excite components, the particulates are effectively burned off (oxidized).

In this connection, each plasma generating means (each exhaust purification unit) 12 employs a spatially non-wasteful structure with the flat-plate electrodes 15 and the arrays of electrode rods 18 being oppositely arranged, so that the capturing area may be increased with no substantial increase in wasteful space by planar increase of the electrodes and arrays of electrode rods 18 while the distance between the electrodes is kept short. Moreover, increase in number of the arranged plasma generating means (the exhaust purification units) 12 may also effectively increase the capturing area. Thus, a plasma-assisted exhaust emission control device 10 may be realized which has better spatial efficiency than the conventional devices.

When the particulates have been captured by the units of plasma generating means 12, the unit of power supply means 23 is connected by the control switch 26 to one of the units of plasma generating means 12 to start burn-off of the particulates in the unit. After completion of the burn-off, the changeover through the control switch 26 is conducted to start the burn-off of the particulates captured by another one of the units of plasma generating means 12; thus, sequentially, the particulates are dealt with for all of the units of plasma generating means 12

Thus, according to the first embodiment of the invention, the plural unitized plasma generating means 12 are arranged to have processing capability comparable to that of a single, large-sized plasma generating means 12. Moreover, to all the units of plasma generating means 23, the connection of the power supply means 23 is sequentially changed over by the control switch 26, so that increase in size of power supply means 23 can be prevented to reduce the cost of production.

According to the plasma generating means 12 thus constructed, the plasma generating means 12 can be realized which has better spatial efficiency than the conventional means, so that mountability of the exhaust emission control device 10 to a vehicle can be substantially improved. Furthermore, the plasma generating means 12 is a spatially non-wasteful structure with the flat-plate electrodes 15 and arrays of electrode rods 18 being oppositely arranged, so that the capturing area can be increased without substantial increase in wasteful space by planar extension of the flat-plate electrodes and arrays of electrode rods while the distance between the plate electrodes is kept short. Increase in number of the arranged units of plasma generating means 12 can also effectively increase the capturing area.

Moreover, according to the first embodiment of the invention, the plasma assisted exhaust emission control device 10 can be realized which has better spatial efficiency than the conventional devices so that mountability of the exhaust emission control device 10 to a vehicle can be substantially improved. By merely increasing or decreasing in number of the arranged plasma generating means (the exhaust purification units) 12, a proper capacity control can be made depending upon engine exhaust amount and particulate discharge amount.

Furthermore, especially in the embodiment, the power feeder 22 is formed by extension through and outside of the rear insulating structure 14 and the power supply means 23 is connected to the power feeder 22 to provide the electric supply system at the downstream side in the direction of the flow of the exhaust gas 8, so that such electric supply system can be protected not to be exposed to the exhaust gas 8 with the particulates entrained therein, whereby preliminarily preventable is the situation that the particulates are attached to and accumulated on the exposed portions of the electric supply system to result in short circulation.

Next, a second embodiment of the invention will be described in conjunction with the drawings.

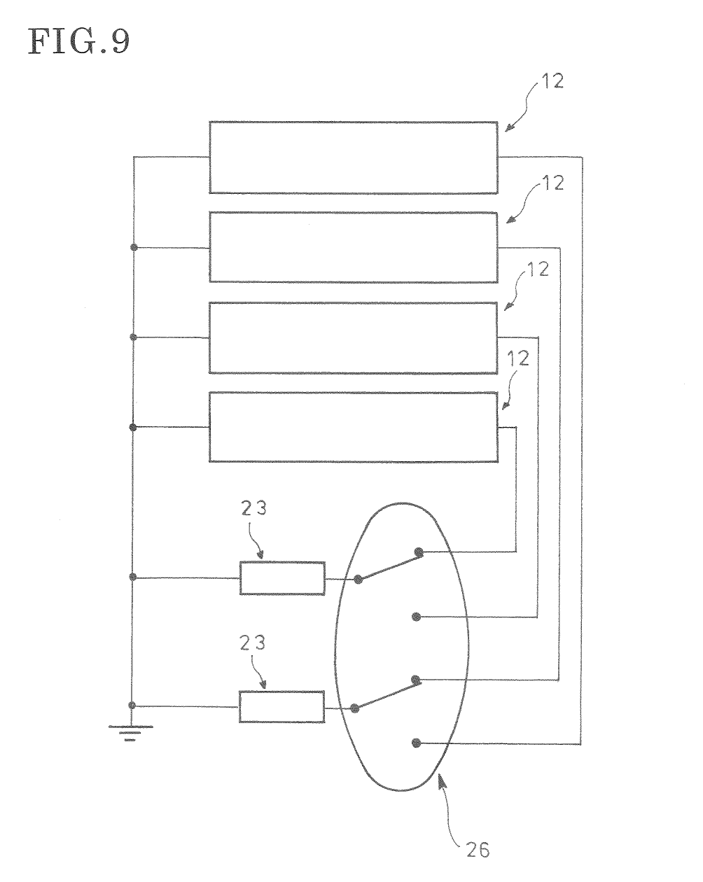

FIG. 9 is directed to the second embodiment of the invention and is a schematic diagram showing the connections between the plural units of plasma generating means 12 and the units of power supply means 23 the connections between the plasma generating means 12 and the power supply means 23 being modified. Each unit of plasma generating means (exhaust purification unit) 12 and the assembly thereof are substantially the same as those of the first embodiment.

The second embodiment comprises, as shown in FIG. 9, two units of power supply means 23 each unit being constituted by the single power supply means 23. The two units of power supply means 23 are switchably connected to separate units of plasma generating means 12 via a control switch 26. Each unit of power supply means 23 is provided with a transformer with a predetermined capacity coping with the electrostatic capacity of the single unit of plasma generating means 12.

The control switch 26 is controlled such that the connection of each unit of power supply means 23 is sequentially changed over between corresponding two units of the plasma generating means 12 so that all of the units of plasma generating means 12 are taken care of by the two units of power supply means 23. The changeover sequence of the control switch 26 may be, for example, such that accumulation of the particles in one of the units of plasma generating means over a predetermined amount is detected to trigger the changeover; alternatively, the changeover may be conducted in a constant sequence and at a constant time interval. There is no specific limitation on the changeover.

When the particulates have been captured by the units of plasma generating means 12, the two units of power supply means 23 are connected by the control switch 26 to corresponding units of plasma generating means 12 to start burn-off of the particulates in the corresponding units. After completion of the burn-off, the changeover through the control switch 26 is conducted to start the burn-off of the particulates captured by the remaining ones of the units of plasma generating means 12, thus, the particulates are dealt with for all of the units of plasma generating means 12.

Thus, according to the second embodiment of the invention, the effects and advantages similar to those of the first embodiment can be obtained. By connecting one or more power supply means to the plural plasma generating means 12, degree of freedom of connection between the units of plasma generating means 12 and power supply means 23 increases, so that particulates can be flexibly and readily dealt with, and increase in size of the power supply means 23 can be prevented to reduce the cost of production.

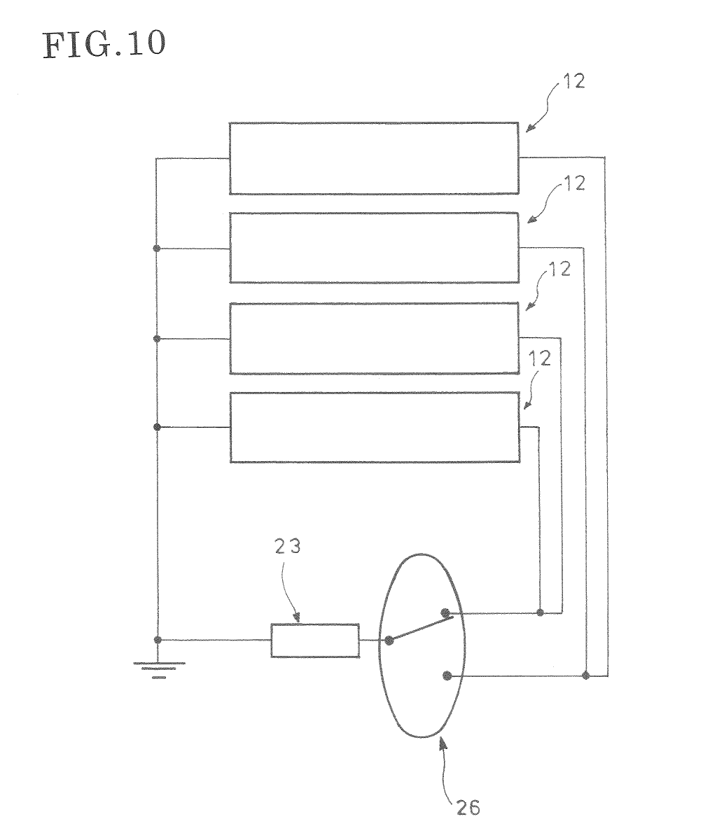

FIG. 10 is directed to a third embodiment of the invention and is a schematic diagram showing the connections between a plurality of plasma generating means 12 and a unit of power supply means 23, a control switch 26 being provided to modify the connections between the plasma generating means 12 and the power supply means 23. Each unit of plasma generating means (exhaust purification unit) 12 and the assembly thereof are substantially the same as those of the first embodiment.

The third embodiment comprises, as shown in FIG. 10, two units of power supply means 23; each unit is constituted by the single power supply means 23 and its concurrent connection to two of units of plasma generating means 12 is changed over by a control switch 26. Each unit of power supply means 23 affords more than twice as much as the electrostatic capacity of each unit of plasma generating means 12.

The control switch 26 is controlled such that the concurrent connection of the single unit of power supply means 23 to two of the units of plasma generating means 12 is sequentially changed over so that all of the units of plasma generating means 12 are taken care of by the single unit of power supply means 23. The changeover sequence of the control switch 26 may be, for example, such that accumulation of the particles in one of the units of plasma generating means over a predetermined amount is detected to trigger the changeover; alternatively, the changeover may be conducted in a constant sequence and at a constant time interval. There is no specific limitation on the changeover.

When the particulates have been captured by the units of plasma generating means 12, the unit of power supply means 23 is connected by the control switch 26 to two of the units of plasma generating means 12 to start burn-off of the particulates. After completion of the burn-off, the changeover through the control switch 26 is conducted to start the burn-off of the particulates captured by the remaining two units of plasma generating means 12; thus, the particulates are dealt with for all of the units of plasma generating means 12.

Thus, according to the third embodiment of the invention, the effects and advantages similar to those of the first and second embodiments can be obtained. The connection of the single power means 23 to two of the units of plasma generating means 12 may reduce the total number of power supply means 23, so that increase in size of the power supply means 23 can be prevented to substantially reduce the cost of production.

It is to be understood that an exhaust emission control device of the invention is not limited to the above embodiments and that various changes and modifications may be made without departing from the scope of the invention.

1-11. (canceled)

12. An exhaust emission control device with plasma generating means received in a filter casing incorporated in an exhaust pipe for capturing particulates and capable of conducting electric discharge so as to generate plasma in the exhaust gas at a capturing place and with power supply means for impressing voltage on the plasma generating means, said device comprising a plurality of unitized or units of plasma generating means and a control switch for sequential changeover of connection of said power supply means to said plurality of units of plasma generating means.

13. An exhaust emission control device as claimed in claim 12, wherein one or more power supplements are connected to the plural units of plasma generating means.

14. An exhaust emission control device as claimed in claim 12, wherein one power supply means is connected to two of the units of plasma generating means.

15. An exhaust emission control device as claimed in claim 12, comprising a pair of flat-plate electrodes arranged opposite to each other with a required gas to provide a vent structure, a plurality of electrode rods arranged between the electrodes and in parallel with each other and each facing via a plasma generating space to the corresponding electrode, the electrode rods being insulation-coated by dielectrics, and filter means constituted by at least either of the electrodes or the plasma generating spaces, the exhaust gas being introduced from upstream into an introduction space defined by two arrays of electrode rods and being passed through gaps between the respective electrode rods, the plasma generating spaces and the electrodes into downstream, a voltage necessary for electric discharge being impressible between the electrodes and electrode rods to thereby provide plasma assisted type plasma generating means, the plasma generating means being arranged in parallel with each other with directions of introducing the exhaust gas being the same, an exhaust space being assured between the adjacent plasma generating means so as to guide the exhaust gas having passed through the electrodes into downstream.

16. An exhaust emission control device as claimed in claim 13, comprising a pair of flat-plate electrodes arranged opposite to each other with a required gas to provide a vent structure, a plurality of electrode rods arranged between the electrodes and in parallel with each other and each facing via a plasma generating space to the corresponding electrode, the electrode rods being insulation-coated by dielectrics, and filter means constituted by at least either of the electrodes or the plasma generating spaces, the exhaust gas being introduced from upstream into an introduction space defined by two arrays of electrode rods and being passed through gaps between the respective electrode rods, the plasma generating spaces and the electrodes into downstream, a voltage necessary for electric discharge being impressible between the electrodes and electrode rods to thereby provide plasma assisted type plasma generating means, the plasma generating means being arranged in parallel with each other with directions of introducing the exhaust gas being the sane, an exhaust space being assured between the adjacent plasma generating means so as to guide the exhaust gas having passed through the electrodes into downstream.

17. An exhaust emission control device as claimed in claim 14, comprising a pair of flat-plate electrodes arranged opposite to each other with a required gas to provide a vent structure, a plurality of electrode rods arranged between the electrodes and in parallel with each other and each facing via a plasma generating space to the corresponding electrode, the electrode rods being insulation-coated by dielectrics, and filter means constituted by at least either of the electrodes or the plasma generating spaces, the exhaust gas being introduced from upstream into an introduction space defined by two arrays of electrode rods and being passed through gaps between the respective electrode rods, the plasma generating spaces and the electrodes into downstream, a voltage necessary for electric discharge being impressible between the electrodes and electrode rods to thereby provide plasma assisted type plasma generating means, the plasma generating means being arranged in parallel with each other with directions of introducing the exhaust gas being the same, an exhaust space being assured between the adjacent plasma generating means so as to guide the exhaust gas having passed through the electrodes into downstream.

18. An exhaust emission control device as claimed in claim 15, wherein the flat-plate electrodes themselves are constituted as filter means.

19. An exhaust emission control device as claimed in claim 16, wherein the flat-plate electrodes themselves are constituted as filter means.

20. An exhaust emission control device as claimed in claim 17, wherein the flat-plate electrodes themselves are constituted as filter means.

21. An exhaust emission control device as claimed in claim 15, wherein filter means are charged in the plasma generating space.

22. An exhaust emission control device as claimed in claim 16, wherein filter means are charged in the plasma generating space.

23. An exhaust emission control device as claimed in claim 17, wherein filter means are charged in the plasma generating space.

24. An exhaust emission control device as claimed in claim 18, wherein filter means are charged in the plasma generating space.

25. An exhaust emission control device as claimed in claim 19, wherein filter means are charged in the plasma generating space.

26. An exhaust emission control device as claimed in claim 20, wherein filter means are charged in the plasma generating space.

27. An exhaust emission control device as claimed in claim 15, wherein the electric supply system is a arranged downstream in the direction of flow of the exhaust gas.

28. An exhaust emission control device as claimed in claim 16, wherein the electric supply system is arranged downstream in the direction of flow of the exhaust gas.

29. An exhaust emission control device as claimed in claim 17, wherein the electric supply system is arranged downstream in the direction of flow of the exhaust gas.

30. An exhaust emission control device as claimed in claim 18, wherein the electric supply system is arranged downstream in the direction of flow of the exhaust gas.

31. An exhaust emission control device as claimed in claim 19, wherein the electric supply system is arranged downstream in the direction of flow of the exhaust gas.

32. An exhaust emission control device as claimed in claim 20, wherein the electric supply system is arranged downstream in the direction of flow of the exhaust gas.

33. An exhaust emission control device as claimed in claim 21, wherein the electric supply system is arranged downstream in the direction of flow of the exhaust gas.

34. An exhaust emission control device as claimed in claim 22, wherein the electric supply system is arranged downstream in the direction of flow of the exhaust gas.

35. An exhaust emission control device as claimed in claim 23, wherein the electric supply system is arranged downstream in the direction of flow of the exhaust gas.

36. An exhaust emission control device as claimed in claim 24, wherein the electric supply system is arranged downstream in the direction of flow of the exhaust gas.

37. An exhaust emission control device as claimed in claim 25, wherein the electric supply system is arranged downstream in the direction of flow of the exhaust gas.

38. An exhaust emission control device as claimed in claim 26, wherein the electric supply system is arranged downstream in the direction of flow of the exhaust gas.
